(19) United States
(12) Patent Application Publication
(10) Pub. No.: US 2007/0238612 A1
(43) Pub. Date: Oct. 11, 2007

(54) Alkali-activated carbon for electric double layer capacitor electrode

(75) Inventors: Takeshi Fujino, Saitama (JP); Shigeki Oyama, Saitama (JP); Minoru Noguchi, Saitama (JP)

Correspondence Address: ARENT FOX PLLC, 1050 CONNECTICUT AVENUE, N.W., SUITE 400, WASHINGTON, DC, 20036, US

(73) Assignees: HONDA GIKEN KOGYO KABUSHIKI KAISHA; KURARAY CHEMICAL CO., LTD.

(21) Appl. No.: 11/648,572

(22) Filed: Jan. 3, 2007

Related U.S. Application Data
(63) Continuation of application No. 10/450,717, filed on Dec. 9, 2003, now abandoned.

(30) Foreign Application Priority Data
Dec. 28, 2000 (JP) 2000-402519

(51) Int. Cl. C01B 31/08

(52) U.S. Cl. 502/416

(57) ABSTRACT

An alkali-activated carbon for an electric double layer capacitor electrode is provided in which the alkali-activated carbon has a first pore group having a pore diameter D in the range of D≦2 nm, a second pore group having a pore diameter D in the range of 2 nm<D≦10 nm, and a third pore group having a pore diameter D in the range of 10 nm<D≦300 nm. When the pore volume of the first pore group is Pv1, the pore volume of the second pore group is Pv2, the pore volume of the third pore group is Pv3, and the sum total Pv0 of the pore volumes is Pv0=Pv1+Pv2+Pv3, the pore volumes being obtained by a nitrogen gas adsorption method, the proportion A of the pore volume Pv1 of the first pore group relative to the sum total Pv0 of the pore volumes is A≧60%, and the proportion B of the pore volume Pv2 of the second pore group relative to the sum total Pv0 of the pore volumes is B≧8%.

### CROSS-REFERENCE TO RELATED APPLICATIONS

This is a Continuation Application which claims the benefit of pending U.S. patent application Ser. No. 10/450,717, filed Dec. 9, 2003, which is a National Stage entry of International Application Number PCT/JP2001/011659, filed Dec. 28, 2001, which claims the priority of Japanese Patent Application Number 2000-402519 filed Dec. 28, 2000. The disclosures of the prior applications are hereby incorporated herein in their entirety by reference.

### FIELD OF THE INVENTION

The present invention relates to an alkali-activated carbon for an electrode of an electric double layer capacitor.

### BACKGROUND ART

The conventional pore diameter range and the role thereof in this type of activated carbon for electrodes are described in, for example, the publication Journal of Power Sources 60 (1996) P233-P238). According thereto, it is said that a group of pores having a pore diameter D in the range of D≧2 nm contributes to the development of capacitance, the diffusion of ions, and the impregnation of an electrolytic solution.

As a result of various investigations by the present inventors into the relationship of the pore distribution to capacitance density (F/cc) and specific resistance (internal resistivity), it has been found that, in order to increase the capacitance density (F/cc) of an activated carbon and decrease the specific resistance thereof, attention should be paid to the amounts of two types of pore groups, that is, those having a pore diameter larger or smaller than a pore diameter D of 2 nm, or the pore volumes of these two types of pore groups, and in order to regulate the pore distribution and the pore volume, an alkali activation treatment is most suitably employed.

### DISCLOSURE OF THE INVENTION

It is an object of the present invention to provide the above-mentioned alkali-activated carbon having specific levels of the above-mentioned two types of pore groups, and having a high capacitance density (F/cc) and a reduced specific resistance.

In order to achieve this object, the present invention provides an alkali-activated carbon for an electric double layer capacitor electrode, the alkali-activated carbon including a first pore group having a pore diameter D in the range of D≦2 nm, a second pore group having a pore diameter D in the range of 2 nm<D≦10 nm, and a third pore group having a pore diameter D in the range of 10 nm<D≦300 nm; and when the pore volume of the first pore group is Pv1, the pore volume of the second pore group is Pv2, the pore volume of the third pore group is Pv3, and the sum total Pv0 of the pore volumes is Pv0=Pv1+Pv2+Pv3, the pore volumes being obtained by a nitrogen gas adsorption method, a proportion A of the pore volume Pv1 of the first pore group relative to the sum total Pv0 of the pore volumes is A≧60%, and a proportion B of the pore volume Pv2 of the second pore group relative to the sum total Pv0 of the pore volumes is B≧8%.

This arrangement can provide an alkali-activated carbon for an electrode, the alkali-activated carbon having a high capacitance density (F/cc) and a reduced specific resistance. However, when the proportion A is less than 60%, the capacitance density (F/cc) decreases, and when the proportion B is less than 8%, the specific resistance increases.

Furthermore, it is another object of the present invention to provide the above-mentioned alkali-activated carbon having specific pore volumes for the above-mentioned two types of pore groups, and having a high capacitance density (F/cc) and a reduced specific resistance.

In order to accomplish this object, the present invention provides an alkali-activated carbon for an electric double layer capacitor electrode, the alkali-activated carbon including a first pore group having a pore diameter D in the range of D≦2 nm and a second pore group having a pore diameter D in the range of 2 nm<D≦10 nm, the pore volume Pv1 of the first pore group determined by a nitrogen gas adsorption method being 0.10 cc/g≦Pv1≦0.44 cc/g, and the pore volume Pv2 of the second pore group determined by the nitrogen gas adsorption method being 0.01 cc/g≦Pv2≦0.20 cc/g.

This arrangement can provide an alkali-activated carbon for an electrode, the alkali-activated carbon having a high capacitance density (F/cc) and a reduced specific resistance. However, even when the first and second pore groups are present, if the pore volume Pv1 is more than 0.44 cc/g, then the capacitance density (F/cc) decreases, and the same applies when Pv1 is less than 0.10 cc/g. If the pore volume Pv2 is more than 0.20 cc/g, the capacitance density (F/cc) decreases, and if Pv2 is less than 0.01, then the specific resistance increases.

### BRIEF DESCRIPTION OF THE DRAWINGS

FIG. 1 is a cutaway front view of an essential part of a button type electric double layer capacitor;

FIG. 2 is a graph showing relationships between pore diameter and pore volume;

FIG. 3 is a graph showing the relationship between a proportion A of a pore volume Pv1 and the capacitance density (F/cc);

and FIG. 4 is a graph showing the relationship between a proportion B of a pore volume Pv2 and the specific resistance.

### BEST MODE FOR CARRYING OUT THE INVENTION

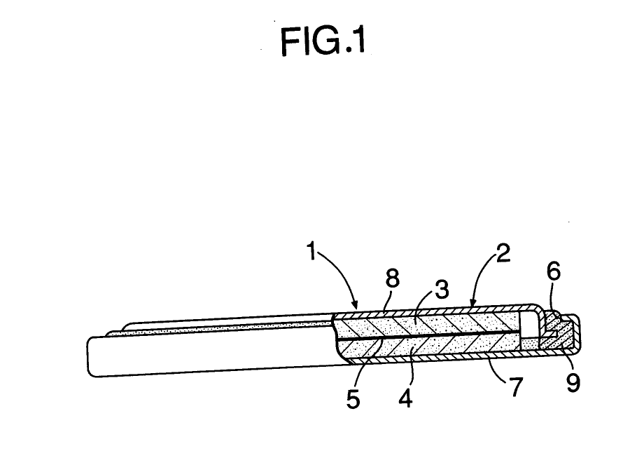

Referring to FIG. 1, a button type electric double layer capacitor 1 has a case 2, a pair of polarizable electrodes 3 and 4 housed within the case 2, a spacer 5 sandwiched between the electrodes 3 and 4, and an electrolytic solution with which the case 2 is filled. The case 2 is formed from an Al container 7 having an opening 6, and an Al lid plate 8 for closing the opening 6, and the gap between an outer peripheral part of the lid plate 8 and an inner peripheral part of the container 7 is sealed by means of a sealing material 9. Each of the polarizable electrodes 3 and 4 is formed from a mixture of an alkali-activated carbon, which is an activated carbon, a conductive filler, and a binder.

The activated carbon for the electrodes has a first pore group contributing to development of capacitance, a second pore group contributing to diffusion of ions and impregnation of an electrolytic solution, and a third pore group contributing to impregnation of an electrolytic solution. The pore diameter D of the first pore group is in the range of D≦2 nm, the pore diameter D of the second pore group is in the range of 2 nm<D≦10 nm, and the pore diameter D of the third pore group is in the range of 10 nm<D≦300 nm.

When the pore volume of the first pore group is Pv1, the pore volume of the second pore group is Pv2, the pore volume of the third pore group is Pv3, and the sum total Pv0 of the pore volumes is Pv0=Pv1+Pv2+Pv3, the pore volumes being obtained by a nitrogen gas adsorption method, a proportion A of the pore volume Pv1 of the first pore group relative to the sum total Pv0 of the pore volumes, that is, A=(Pv1/Pv0)×100 (%), is set so that A≧60%. Furthermore, a proportion B of the pore volume Pv2 of the second pore group relative to the sum total Pv0 of the pore volumes, that is, B=(Pv2/Pv0)×100 (%), is set so that B≧8%.

The pore volume Pv1 of the first pore group is set so that 0.10 cc/g≦Pv1≦0.44 cc/g, the pore volume Pv2 of the second pore group is set so that 0.01 cc/g≦Pv2≦0.20 cc/g, and the pore volume Pv3 of the third pore group is set so that 0.01 cc/g≦Pv3≦0.03 cc/g.

Production of the alkali-activated carbon for the electrodes employs a step of subjecting a starting material, which is an aggregate of individuals, to an oxygen cross-linking treatment so as to obtain an oxygen adduct in which oxygen is distributed throughout the interior of the individuals, a step of subjecting the oxygen adduct to a carbonization treatment so as to obtain a carbide material, and a step of subjecting the carbide material to an alkali activation treatment using KOH so as to obtain an alkali-activated carbon.

In this case, while considering that the pore distribution and the pore volume are determined by the alkali activation treatment, which is the final step, the starting material is selected, the oxygen cross-linking conditions and the carbonization conditions are set, and the amount of KOH and the treatment temperature, etc. of the alkali activation treatment are regulated.

For example, if the carbonization temperature is too high, since the true density of the carbide material is high, pores cannot be formed smoothly by the alkali activation treatment, and as a result the pore volume of the alkali-activated carbon is too small. If the amount of KOH is too large, then pore formation due to K₂CO₃ proceeds, and thus the pore volume of the alkali-activated carbon is too large.

From these viewpoints, as the starting material there is used a powder of, for example, a petroleum pitch, which can give an easily graphitizable carbon, a mesophase pitch (a coal mesophase pitch, a petroleum mesophase pitch, a synthetic mesophase pitch), polyvinyl chloride, polyimide, or PAN, a fibrous aggregate (including an aggregate of spun fibrous materials), etc. The individual in the powder refers to one particle, and the individual in the fibrous aggregate refers to one fiber or one fibrous material.

The oxygen cross-linking treatment is carried out by a method such as one in which a starting material is heated in air to a predetermined temperature at a predetermined rate of temperature increase or one in which, after the temperature reaches a predetermined temperature, this temperature is maintained for a predetermined period of time.

Distributing oxygen throughout the interior of a plurality of individuals by such an oxygen cross-linking treatment can cause the subsequent alkali-activation reaction to occur uniformly throughout the oxygen adduct so as to increase the pore volume Pv1 of the first pore group, and when the polarizable electrodes 3 and 4 are formed using the alkali-activated carbon, the amount of expansion of the polarizable electrodes 3 and 4 when they are charged can be reduced.

When the weight of the starting material is W, and the weight of the oxygen adduct, that is, W+the amount of oxygen, is X, the degree of oxygen cross-linking Y by the oxygen cross-linking treatment can be expressed by Y={(X−W)/W}×100 (%), and the degree of oxygen cross-linking Y is set so that 2%≦y≦20%. When the degree of oxygen cross-linking Y is less than 2%, the effect of suppressing the expansion of the polarizable electrodes is insufficient, and on the other hand, when Y is more than 20%, carbon burns during the following carbonization step, and the yield of the carbide material decreases.

In order to confine the degree of oxygen cross-linking Y within the above-mentioned range, the rate V of temperature increase in the oxygen cross-linking treatment is set so that 1° C./min≦V≦20° C./min, the heating temperature T is set so that 150° C.≦T≦350° C., and the retention time t is set so that 1 min≦t≦10 hours. In order to promote the oxygen cross-linking treatment, it is also possible to use P₂O₅, quinone, hydroquinone, etc. or derivatives derived mainly from these materials.

The carbonization treatment is carried out under known conditions that are employed in this type of production process. That is, it is carried out under an atmosphere of an inert gas, the heating temperature T is set so that 600° C.≦T≦1000° C., and the heating time t is set so that 1 min≦t≦10 hours. The true density Dt of the carbide material is specified so that 1.4 g/cc≦Dt≦1.8 g/cc in order to obtain the above-mentioned pore volume.

The alkali activation treatment is carried out under known conditions that are employed in this type of production process. That is, it is carried out under an atmosphere of an inert gas, the heating temperature T is set so that 500° C.≦T≦1000° C., and the heating time t is set so that 1 hour≦t≦10 hours. The ratio by weight of KOH to the carbide material C, KOH/C, is specified so that 1.0≦KOH/C≦3.0 in order to obtain the above-mentioned pore volume.

Specific examples are explained below.

A. Production of Alkali-Activated Carbon

1. Oxygen Cross-Linking Treatment

(a) As starting materials, there were prepared a first mesophase pitch having a softening point of 270° C. to 290° C., a second mesophase pitch having a softening point of 230° C. to 260° C., and a third mesophase pitch having a softening point of 150° C. to 200° C. Spinning using the first mesophase pitch gave an aggregate formed from a fibrous material having a diameter of 13 μm, use of the second mesophase pitch gave a first powder having an average particle size of 20 μm, and use of the third mesophase pitch gave a second powder having an average particle size of 20 μm. (b) The aggregate of the fibrous material was subjected to oxygen cross-linking treatments under various conditions to give oxygen adduct Samples 1 to 6, and 01. Furthermore, the first and second powders were subjected to oxygen cross-linking treatments under various conditions to give oxygen adduct Samples 7 and 8 respectively. (c) The degree of oxygen cross-linking Y was determined for Samples 1 to 8, and 01, and Sample 02, which was obtained using the second powder as the starting material without carrying out an oxygen cross-linking treatment.

Table 1 shows the oxygen cross-linking treatment conditions and the degree of oxygen cross-linking Y for Samples 1 to 8, 01, and 02.

TABLE 1

| | Oxygen cross-linking treatment conditions | | | |
|---|---|---|---|---|
| | Rate of | | | Degree of |
| | temperature | Heating | Retention | oxygen |
| Oxygen | increase V | temperature T | time t | cross-linking |
| adduct | (° C./min) | (° C.) | (h) | Y (%) |
| Sample 1 | 5 | 280 | — | 3 |
| Sample 2 | 5 | 280 | — | 3 |
| Sample 3 | 5 | 300 | 0.5 | 7 |
| Sample 4 | 5 | 300 | 0.5 | 7 |
| Sample 5 | 5 | 300 | 0.5 | 7 |
| Sample 6 | 5 | 300 | 0.5 | 7 |
| Sample 7 | 5 | 300 | 6 | 6 |
| Sample 8 | 5 | 170 | 6 | 0.1 |
| Sample 01 | 5 | 280 | — | 3 |
| Sample 02 | — | — | — | 0 |

In Table 1, if the retention time is not mentioned it means that, when the furnace temperature reached the heating temperature, the oxygen adduct was moved to the following carbonization treatment.

2. Carbonization Treatment

Oxygen adduct Samples 1 to 8, and 01, and Sample 02 were subjected to a carbonization treatment in a flow of nitrogen to give easily graphitizable carbon fiber Samples 1 to 6, and 01 and easily graphitizable carbon powder Samples 7, 8, and 02, which corresponded to oxygen adduct Samples 1 to 8, and 01, and Example 02.

The carbonization conditions and the true density Dt of Samples 1 to 8, 01, and O₂ are as shown in Table 2. The true density Dt was evaluated by a specific gravity conversion method using butanol.

TABLE 2

| Carbon fiber | Carbonization treatment | | True Density Dt |
|---|---|---|---|
| Carbon powder | Temperature (° C.) | Time (h) | (g/cc) |
| Sample 1 | 700 | 1 | 1.52 |
| Sample 2 | 700 | 1 | 1.52 |
| Sample 3 | 700 | 1 | 1.55 |
| Sample 4 | 700 | 1 | 1.55 |
| Sample 5 | 700 | 1 | 1.55 |
| Sample 6 | 700 | 1 | 1.55 |
| Sample 7 | 700 | 1 | 1.52 |
| Sample 8 | 700 | 1 | 1.52 |
| Sample 01 | 650 | 1 | 1.45 |
| Sample 02 | 750 | 1 | 1.63 |

The oxygen concentration in a diameter part of each of the carbon fibers and carbon powders of Samples 1 to 8, and 01 was determined by TEM-EDX electron beam step scanning, and it was found that the adduct oxygen was distributed throughout the interior.

3. Pulverization Treatment

Carbon fiber Samples 1 to 6, and 01 were subjected to a pulverization treatment to give carbon powder Samples 1 to 6, and 01 having an average particle size of 20 μm.

4. Alkali Activation Treatment

Carbon powder Samples 1 to 8, 01, and 02 were subjected to an alkali activation treatment in a flow of nitrogen using KOH (purity: 85%) to give alkali-activated carbon powders having an average particle size of 20 μm of Examples 1 to 8 and Comparative Examples 01 and 02, which corresponded to Samples 1 to 8, 01, and 02 above.

Table 3 shows the alkali activation conditions for Examples 1 to 8 and Comparative Examples 01 and 02.

TABLE 3

| | Alkali activation treatment conditions | | | | |
|---|---|---|---|---|---|
| Alkali- | | Primary treatment | | Secondary treatment | |
| activated | | Temp. | Time | Temp. | Time |
| carbon | KOH/C | (° C.) | (h) | (° C.) | (h) |
| Example 1 | 2 | 450 | 3 | 770 | 3 |
| Example 2 | 2 | 450 | 3 | 730 | 3 |
| Example 3 | 2 | 450 | 3 | 730 | 3 |
| Example 4 | 2.2 | 730 | 3 | — | — |
| Example 5 | 2.2 | 450 | 3 | 730 | 3 |
| Example 6 | 2.2 | 450 | 3 | 700 | 3 |
| Example 7 | 2 | 450 | 3 | 800 | 3 |
| Example 8 | 2 | 450 | 3 | 800 | 3 |
| Comparative | 2 | 450 | 3 | 730 | 3 |
| Example 01 | | | | | |
| Comparative | 2 | 450 | 3 | 730 | 3 |
| Example 02 | | | | | |

B. Pore Distribution and Pore Volume of Alkali-Activated Carbon

The alkali-activated carbon of Example 1 was subjected to a pore distribution measurement using a nitrogen gas adsorption method. The measurement conditions were as follows. Example 1: degassed in vacuum at 300° C. for about 6 hours, using 0.1 to 0.4 g as a sample; pore distribution measurement equipment: ASAP2010 (product name) manufactured by Shimadzu Corporation; pore distribution analysis used analytical software V2.0.

Pore volume was calculated by the following method. Firstly, the volume of pores having a pore diameter D in the range of D≦300 nm, that is, the sum total Pv0 of the pore volumes Pv1, Pv2, and Pv3 of the first to third pore groups, was determined from a pore distribution data obtained by a [P/P_{O}]=0.986 single point measurement method. The pore volume of a pore group having a pore diameter D in the range of 2 nm<D≦300 nm was determined by a BJH Adsorption Pore Distribution. Since this pore volume is equal to the sum of the pore volumes of the second and third pore groups (Pv2+Pv3), Pv0−(Pv2+Pv3) was calculated to give the pore volume Pv1 of the first pore group having a pore diameter D in the range of D≦2 nm. In this case, the lower limit for the pore diameter D measured by the nitrogen gas adsorption method was 0.4 nm. The pore volumes Pv2 and Pv3 of the second and third pore groups were each determined from a value obtained by the BJH Adsorption Pore Distribution.

In the same manner, the pore volumes Pv1 to Pv3 for the alkali-activated carbons of Examples 2 to 8 and Comparative Examples 01 and 02 were determined. Specific values for the pore volumes Pv1 to Pv3 thereof are described later.

C. Fabrication of Button Type Electric Double Layer Capacitor

The alkali-activated carbon of Example 1, carbon black (conductive filler), and PTFE (binder) were weighed at a ratio by weight of 85.6:9.4:5, the weighed materials were then kneaded, and the kneaded material was then rolled to give an electrode sheet having a thickness of 185 μm. Two polarizable electrodes 3 and 4 having a diameter of 20 mm were cut out of the electrode sheet, and a button type electric double layer capacitor 1 of FIG. 1 was fabricated using these two polarizable electrodes 3 and 4, a glass fiber spacer 5 having a diameter of 25 mm and a thickness of 0.35 mm, an electrolytic solution, etc. As the electrolytic solution a 1.8 M propylene carbonate solution of triethylmethylammonium tetrafluoroborate [(C₂H₅)₃CH₃NBF₄] was used.

Nine types of button type electric double layer capacitors were also fabricated by the same method as above using the alkali-activated carbon of Examples 2 to 8, and Comparative Examples 01 and 02.

D. Capacitance Density (F/cc) of Alkali-Activated Carbon

Each of the button type electric double layer capacitors was subjected to the charge and discharge test below, and the capacitance density (F/cc) per unit volume of the alkali-activated carbons of Examples 1 to 8, and Comparative Examples 01 and 02 was determined by an energy conversion method. The charge and discharge test employed a method in which 90 min charging and 90 min discharging were carried out at 2.7 V and a current density of 5 mA.

E. Discussion

Table 4 shows the sum total Pv0 of the pore volumes, the pore volumes Pv1 to Pv3 of the first to third pore groups, the specific surface area, the apacitance density (F/cc), and the specific resistance of the alkali-activated carbons of Examples 1 to 8, and Comparative Examples 01 and 02. In the table, D is the pore diameter (nm).

TABLE 4

| | Pore volume (cc/g) | | | | | | |
|---|---|---|---|---|---|---|---|
| Alkali- | Sum | First pore group | Second pore group | Third pore group | Specific | Capacitance | Specific |
| activated | total | (D ≦ 2) | (2 < D ≦ 10) | (10 < D ≦ 300) | area | density | resistance |
| carbon | Pv0 | Pv1 | Pv2 | Pv3 | (m²/g) | (F/cc) | (Ω · cm²) |
| Example 1 | 0.54 | 0.33 | 0.20 | 0.01 | 1155 | 30.0 | 13.21 |
| Example 2 | 0.54 | 0.44 | 0.09 | 0.01 | 1100 | 30.5 | 15.48 |
| Example 3 | 0.45 | 0.35 | 0.08 | 0.03 | 906 | 32.0 | 11.90 |
| Example 4 | 0.37 | 0.28 | 0.06 | 0.03 | 728 | 32.1 | 13.86 |
| Example 5 | 0.28 | 0.22 | 0.03 | 0.03 | 563 | 33.4 | 16.11 |
| Example 6 | 0.26 | 0.19 | 0.04 | 0.03 | 526 | 34.0 | 15.93 |
| Example 7 | 0.25 | 0.18 | 0.05 | 0.02 | 487 | 39.8 | 13.60 |
| Example 8 | 0.12 | 0.10 | 0.01 | 0.01 | 245 | 41.0 | 17.10 |
| Comparative | 1.20 | 0.50 | 0.67 | 0.03 | 2300 | 27.0 | 13.01 |
| Example 01 | | | | | | | |
| Comparative | 0.41 | 0.39 | 0.009 | 0.001 | 886 | 33.0 | 30.00 |
| Example 02 | | | | | | | |

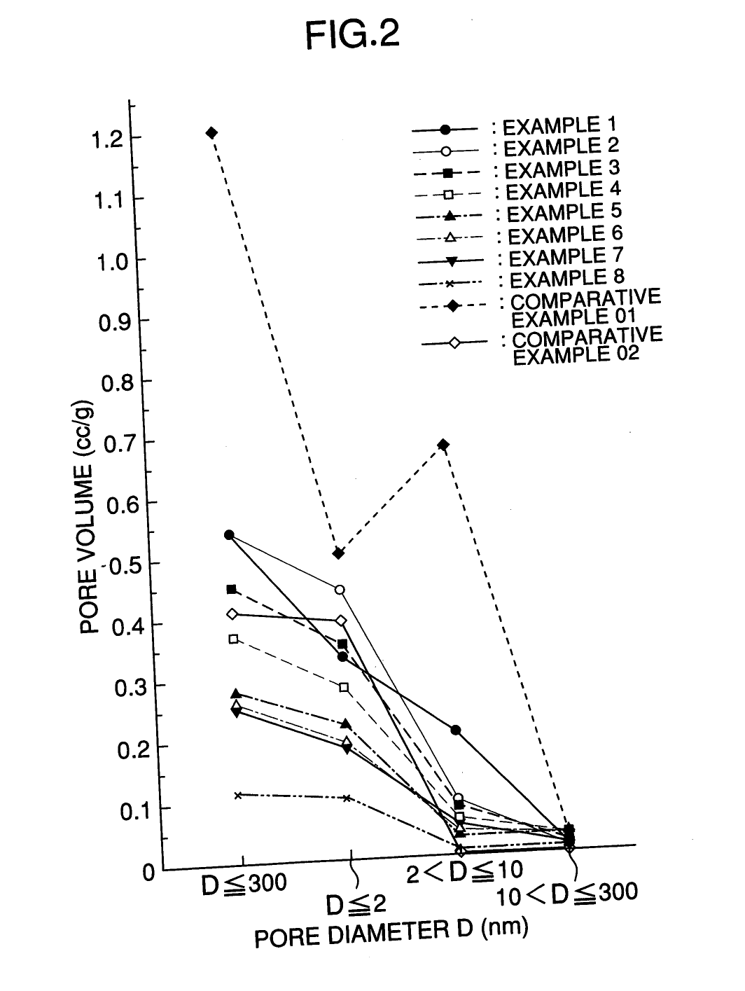

FIG. 2 is a graph based on Table 4 showing the relationship between the pore diameter and the pore volume for Examples 1 to 8 and Comparative Examples 01 and 02.

As is clear from Table 4 and FIG. 2, Examples 1 to 8, in which the pore volume Pv1 of the first pore group is in the range of 0.10 cc/g≦Pv1≦0.44 cc/g and the pore volume Pv2 of the second pore group is in the range of 0.01 cc/g≦Pv2≦0.20 cc/g, has a high capacitance density (F/cc) and a low specific resistance. On the other hand, the capacitance density (F/cc) of Comparative Example 01 is lower than those of Examples 1 to 8 since the pore volumes Pv1 and Pv2 fall outside the above-mentioned ranges, and Comparative Example 02 has a high specific resistance since the pore volume Pv2 falls outside the above-mentioned range.

Table 5 shows the relationship between the capacitance density (F/cc) and the proportion A of the pore volume Pv1 of the first pore group relative to the sum total Pv0 of the pore volumes.

TABLE 5

| | Proportion A of Pv1 | Capacitance density |
|---|---|---|
| | (%) | (F/cc) |
| Example 1 | 61.11 | 30.0 |
| Example 2 | 81.48 | 30.5 |
| Example 3 | 77.78 | 32.0 |
| Example 4 | 75.68 | 32.1 |
| Example 5 | 78.57 | 33.4 |
| Example 6 | 73.08 | 34.0 |
| Example 7 | 72.00 | 39.8 |
| Example 8 | 83.33 | 41.0 |
| Comparative Example 01 | 41.67 | 27.0 |
| Comparative Example 02 | 95.12 | 33.0 |

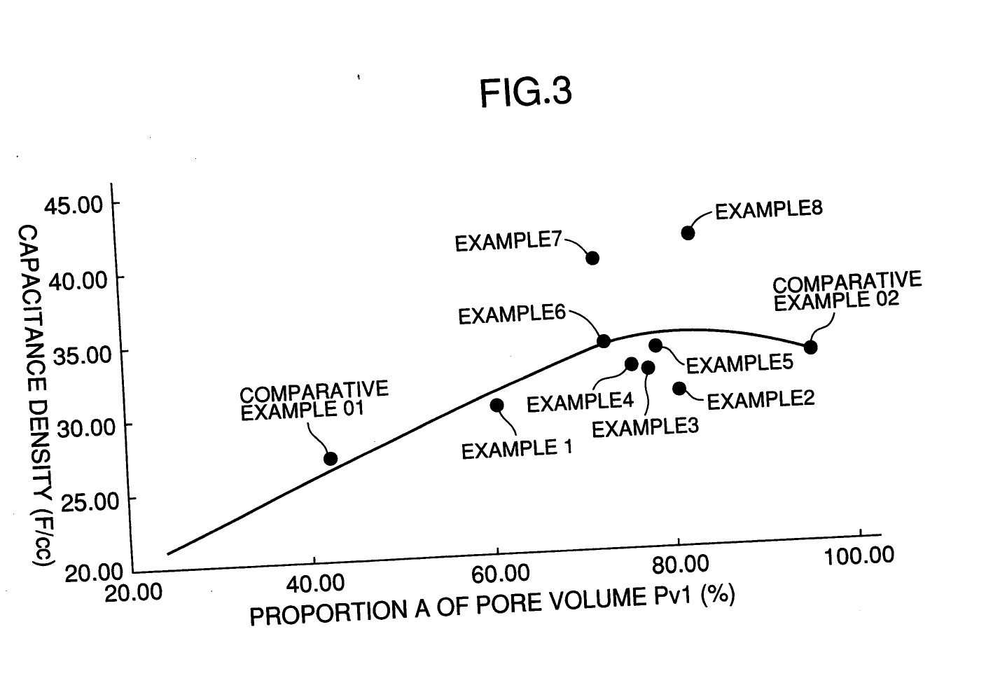

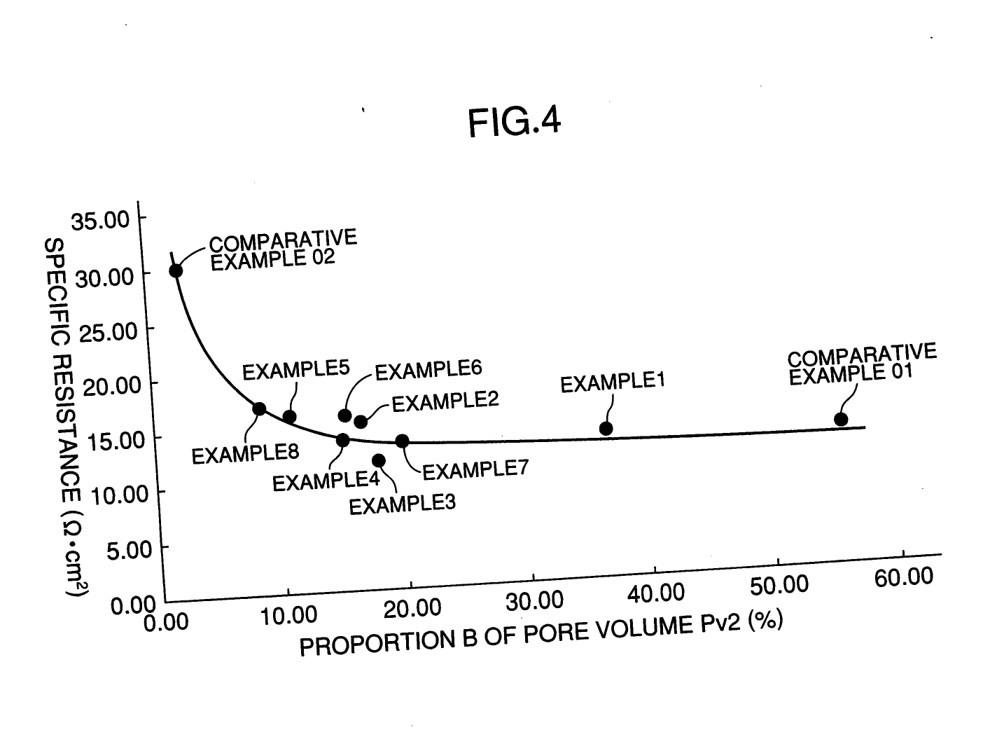

FIG. 3 is a graph based on Table 5 showing the relationship between the proportion A of the pore volume Pv1 and the capacitance density (F/cc). As is clear from Table 5 and FIG. 3, setting the proportion A so that A≧60% can increase the capacitance density (F/cc).

Table 6 shows the relationship between the specific resistance and the proportion B of the pore volume Pv2 of the second pore group relative to the sum total Pv0 of the pore volumes.

TABLE 6

| | Proportion B of Pv2 | Specific resistance |
|---|---|---|
| | (%) | (Ω · cm²) |
| Example 1 | 37.04 | 13.21 |
| Example 2 | 16.67 | 15.48 |
| Example 3 | 17.78 | 11.90 |
| Example 4 | 16.22 | 13.86 |
| Example 5 | 10.71 | 16.11 |
| Example 6 | 15.38 | 15.93 |
| Example 7 | 20.00 | 13.60 |
| Example 8 | 8.33 | 17.10 |
| Comparative Example 01 | 55.83 | 13.01 |
| Comparative Example 02 | 2.12 | 30.00 |

FIG. 4 is a graph based on Table 6 showing the relationship between the proportion B of the pore volume Pv2 and the specific resistance. As is clear from Table 6 and FIG. 4, setting the proportion B so that B≧8% can decrease the specific resistance.

It is clear from Table 4 that it is very difficult to predict, from the specific surface area, an optimum pore distribution of an alkali-activated carbon for an electric double layer capacitor.

What is claimed is:

1. An electric double layer capacitor comprising an electrode made using an alkali-activated carbon, the alkali-activated carbon comprising a first pore group having a pore diameter D in the range of D≦2 nm, a second pore group having a pore diameter D in the range of 2 nm<D≦10 nm, and a third pore group having a pore diameter D in the range of 10 nm<D≦300 nm; when the pore volume of the first pore group is Pv1, the pore volume of the second pore group is Pv2, the pore volume of the third pore group is Pv3, and the sum total Pv0 of the pore volumes is Pv0=Pv1+Pv2+Pv3, the pore volumes being obtained by a nitrogen gas adsorption method, a proportion A of the pore volume Pv1 of the first pore group relative to the sum total Pv0 of the pore volumes being A≧60%, and a proportion B of the pore volume Pv2 of the second pore group relative to the sum total Pv0 of the pore volumes being B≧8%.

2. An electric double layer capacitor comprising an electrode made using an alkali-activated carbon, the alkali-activated carbon comprising a first pore group having a pore diameter D in the range of D≦2 nm and a second pore group having a pore diameter D in the range of 2 nm<D≦10 nm, the pore volume Pv1 of the first pore group determined by a nitrogen gas adsorption method being 0.10 cc/g≦Pv1≦0.44 cc/g, and the pore volume Pv2 of the second pore group determined by the nitrogen gas adsorption method being 0.01 cc/g≦Pv2≦0.20 cc/g.

3. An electric double layer capacitor comprising an electrode made using an alkali-activated carbon, the alkali-activated carbon comprising a first pore group having a pore diameter D in the range of D≦2 nm and a second pore group having a pore diameter D in the range of 2 nm<D≦10 nm, and a third pore group having a pore diameter in the range of 10 nm<D≦300 nm; when the pore volume of the first pore group is Pv1, the pore volume of the second pore groups is Pv2, the pore volume of the third pore group is Pv3, and the sum total Pv0 of the pore volumes is Pv0=Pv1+Pv2+Pv3, the pore volumes being obtained by a nitrogen gas adsorption method, the pore volume Pv1 of the first pore group being 0.10 cc/g≦Pv1≦0.44 cc/g and a proportion A of the pore volume Pv1 relative to the sum total Pv0 of the pore volumes being A≧60%.

4. The electric double layer capacitor according to claim 3, wherein the pore volume Pv2 of the second pore group is 0.01 cc/g≦Pv2≦0.20 cc/g.
